(19) United States
(12) Patent Application Publication
(10) Pub. No.: US 2018/0174263 A1
(43) Pub. Date: Jun. 21, 2018

(54) METHOD AND DEVICE FOR DISPATCHING SHUTTLE VEHICLES

(71) Applicant: TELEFONAKTIEBOLAGET LM ERICSSON (PUBL), Stockholm (SE)

(72) Inventor: Aylene Gracie, Ottawa (CA)

(73) Assignee: TELEFONAKTIEBOLAGET LM ERICSSON (PUBL), Stockholm (SE)

(21) Appl. No.: 15/384,748

(22) Filed: Dec. 20, 2016

(51) Int. Cl. G06Q 50/30; G06Q 10/06; G06K 19/04; G06K 19/07; G06K 19/06

(52) U.S. Cl. CPC G06Q 50/30; G06Q 10/06315; G06K 19/06028; G06K 19/0723; G06K 19/041

(57) ABSTRACT

A method for dispatching vehicles to a destination that is associated with a service is provided. The method comprises: determining a count of tickets associated with the service in response to receiving one or more identifiers of the tickets associated with the service, the received one or more identifiers being associated with one or more pick-up locations; determining a number of vehicles to be dispatched based on the determined count; and sending a signal for dispatching the number of vehicles to the one or more pick-up locations.

### TECHNICAL FIELD

This disclosure relates generally to a method and a device for dispatching vehicles for public transportation or event/service related transportation.

### BACKGROUND

When people are waiting for a transportation shuttle to a special event, such as a hockey game, the current technology depends on time cadence for dispatch of shuttle buses based on historical data. Buses leave at regular intervals to pick up event-goers at several pick-up spots. The problem is that the people at the stop closest to the event site will very often have the issue of “no room left” on the bus because the bus is filled up at earlier stops. As such, the people will need to wait several intervals of time for the aggregate demand at the earlier stops to drop to below bus capacity. The current approach to solving this problem is to collect historical usage information and try to finesse the time cadence in order to reduce the occurrence of this issue.

The challenge is that the demand for the shuttle buses is dynamic so the current time-based approach is not appropriate. As such, there is still a need to address the problem as described above.

### SUMMARY

According to a first aspect of the invention, there is provided a method for dispatching vehicles to a destination that is associated with a service. The method comprises: determining a count of tickets associated with the service in response to receiving one or more identifiers of the tickets associated with the service, the received one or more identifiers being associated with one or more pick-up locations; determining a number of vehicles to be dispatched based on the determined count; and sending a signal for dispatching the number of vehicles to the one or more pick-up locations

According to a second aspect of the invention, there is provided a device for dispatching vehicles to a destination associated with a service. The device comprises a processing circuitry adapted to cause the device to: determine a count of tickets associated with the service in response to receiving one or more identifiers of the tickets associated with the service, the received one or more identifiers being associated with one or more pick-up locations; determine a number of vehicles to be dispatched based on the determined count; and send a signal for dispatching the number of vehicles to the one or more pick-up locations.

According to a third aspect of the invention, there is provided a system for dispatching vehicles to a destination associated with a service. The system comprises at least one pick-up device and at least one dispatch device, wherein the at least one pick-up device and the at least one dispatch device are connected to a server. The at least one pick-up device and the at least one dispatch device are configured to cause the system to: receive one or more identifiers of tickets associated with the services, at one or more pick-up locations; send the received one or more identifiers to the server, which transmits the one or more identifiers to the at least one dispatch device; determine a count of tickets associated with the service in response to receiving the one or more identifiers; determine a number of vehicles to be dispatched based on the determined count; and send a signal to the number of vehicles to be dispatched to the one or more pick-up locations.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 illustrates a schematic diagram of a system for dispatching vehicles to a destination, according to an embodiment.

FIG. 2 illustrates a schematic block diagram of a pick-up device and a dispatch device according to an embodiment.

FIG. 3 illustrates a schematic block diagram of a processing circuitry of a pick-up device according to another embodiment.

FIG. 4 illustrates a schematic block diagram of a processing circuitry of a dispatch device according to another embodiment.

FIGS. 5A and 5B illustrate a signaling diagram between the different devices of the system of FIG. 1, according to an embodiment.

FIG. 6 illustrates a flow chart of a method for dispatching vehicles to a destination associated with a service, according to an embodiment.

FIG. 7 illustrates a schematic diagram of a dispatch device according to another embodiment.

FIG. 8 illustrates a cloud computing environment for performing the method of FIG. 6.

### DETAILED DESCRIPTION

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

As mentioned above, since the demand for transportation is dynamic, the solution cannot rely on a time-based approach. Indeed, time-based approaches do not solve the problem at its source and can still cause people to wait at the pick-up locations, even though the frequency of bus arrival may be increased. The fact that people have to wait may lead to frustrated users and to people preferring to use their own cars to get to the event site, for example.

Generally stated, embodiments of the present disclosure provide for a method, a device and a system for dispatching a number of vehicles for transporting people based on a number/count of valid tickets associated with an event or service.

For example, in case of an event, the embodiments use a scanner at each shuttle bus pick-up location. Ticket-holders for the event scan their event ticket as a unique identifier to be counted as waiting for the shuttle bus. When this real-time data of countable users waiting at each pick-up location is communicated to the shuttle buses, the embodiments can automatically signal a dispatch instruction to one or more next shuttle buses to optimize the passenger pick-up. This provides a real-time demand-driven dispatch of the shuttle buses that doesn't penalize the people who are not waiting at the first few pick-up locations.

It should be noted that the terms “shuttle”, “shuttle buses”, “shuttle vehicles” or “vehicles” can be used interchangeably in this disclosure.

Now, let's consider a destination that is associated with a service. For example, there is a special event in town. Special events include sporting events, parades, fairs, and other planned events, such as a hockey game or a concert by a popular rock band. In the example, the destination is the event site and the service associated with the destination is the event itself. In order to enjoy the service associated with the destination, people need to buy tickets that are associated with the service. The tickets associated with the service can be also referred to as service tickets, the service being different from the shuttle transportation service. In the example, the tickets associated with the service would be the tickets to go to the event, also referred to as event tickets.

In the example, to help with the transportation to the event site, shuttle buses or vehicles are made available for people who are going to the event. There are several pick-up locations across the town for people to wait for the shuttle buses that will take them to the event site.

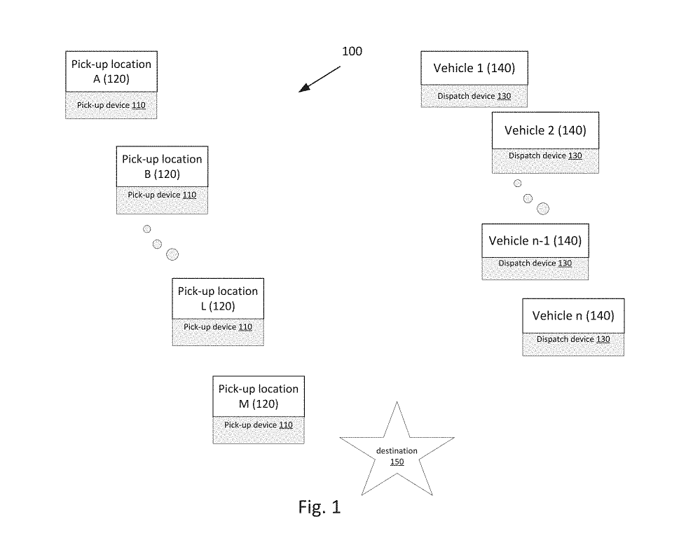

Now, turning to FIG. 1, a system for dispatching vehicles to the pick-up locations to pick-up passengers, according to an embodiment is disclosed. The system 100 comprises a plurality of pick-up devices 110, associated with a plurality of pick-up areas or locations 120, e.g. A to M, which are on the way to a destination 150 that provides a service. For example, the pick-up devices 110 are installed in the pick-up locations 120.

The system 100 also comprises a plurality of dispatch devices 130 installed in a plurality of vehicles 140, e.g. 1 to n.

Both the plurality of pick-up devices 110 and dispatch devices 130 are connected to a central server (not shown in FIG. 1), which can be a web-based server, for example.

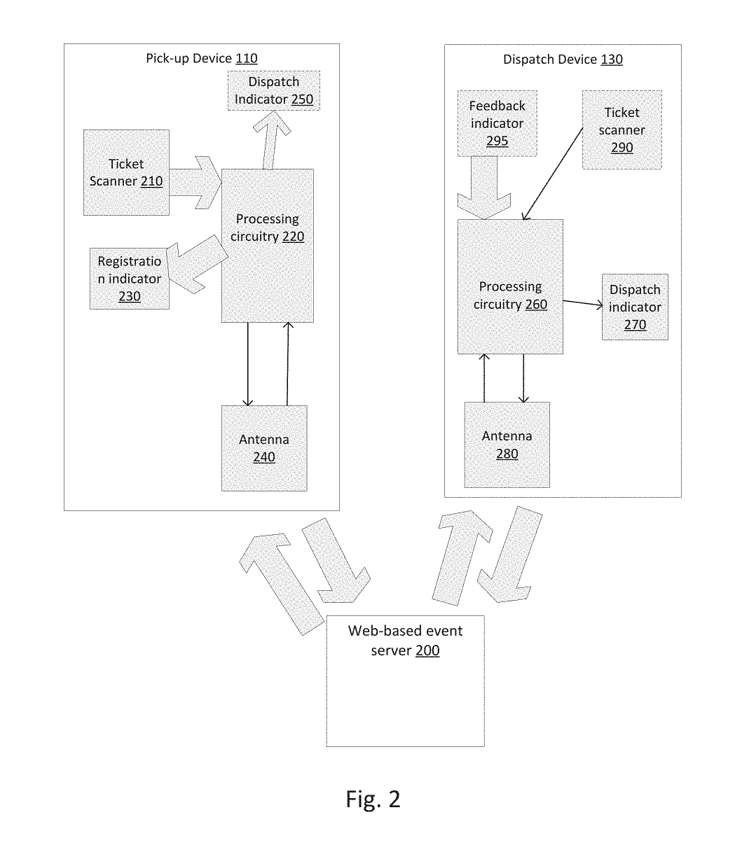

FIG. 2 shows in more detail a pick-up device 110 and a dispatch device 130, both of which are connected to a central server 200.

All the pick-up devices 110 are similar to each other, as such, for sake of simplicity, only one pick-up device 110 will be described hereinbelow.

The pick-up device 110 may comprise a ticket scanner 210, a processing circuitry 220, a registration indicator 230, an antenna 240 and optionally a dispatch indicator 250.

When an user arrives at a specific pick-up location 120 and wants to request a shuttle vehicle for a ride to the destination 150 for a service, he/she scans his/her ticket associated with the service using the ticket scanner 210. The ticket scanner 210 can read a barcode, a Radio Frequency IDentification (RFID), and any other scannable identifiers associated with the service. As such, the service ticket can comprise a barcode or a RFID or any scannable identifiers associated with the service. Once the service ticket is scanned, the ticket scanner 210 extracts the unique identifier and sends it to the processing unit 220. The unique identifier is used to count the number of users that need a shuttle vehicle or are waiting for the shuttle vehicle at a specific pick-up location 120. Furthermore, the time at which the service ticket was scanned can be also recorded through timestamps. In addition to the unique identifier, the ticket scanner 210 can also send the timestamps to the processing unit 220.

After the processing circuitry 220 receives the unique identifier, it can check the validity of the service ticket that has that unique identifier. To do so, the processing circuitry 220 compares the unique identifier of the service ticket against a known list of valid ticket numbers/identifiers for the service. For example, this comparison list can be downloaded from the central server 200. The processing circuitry 220 communicates with the central server 200 via the antenna 240, for example. The antenna 240 could use multiple protocols for communicating with the server 200, using e.g. cellular communications or Wi-Fi or any other wireless communications.

If a unique and valid service ticket identifier is detected in the list that corresponds to the scanned identifier, the pick-up device 110, through the processing circuitry 220, reports an event, i.e. one person is waiting for the shuttle vehicle at the specific location 120, to the server 200. Additionally, the event report can also include the scanned service ticket identifier and the timestamp.

Furthermore, the pick-up device 110 can give an indication to the users that their service ticket has been successfully counted and processed. To do so, when the service tickets identifiers are validated by the processing circuitry 220, the registration indicator 130 can issue an indication of successful registration to the users. The indication could be a light of a certain colour, a message, an audible sound, etc.

Also, the pick-up device 110 can listen to the server 200 for reported events of shuttle vehicles that have been dispatched. Through these reported events, the pick-up device 110 can be informed of how many shuttle vehicles have been dispatched or about to be dispatched, for example. Once the processing circuitry 220 receives those reported events, it can use the dispatch indicator 250 to notify the users about the shuttle vehicles that have been dispatched. For example, the number of shuttle vehicles that have been dispatched can be displayed or the time when they will arrive at the specific location can be displayed as well, etc.

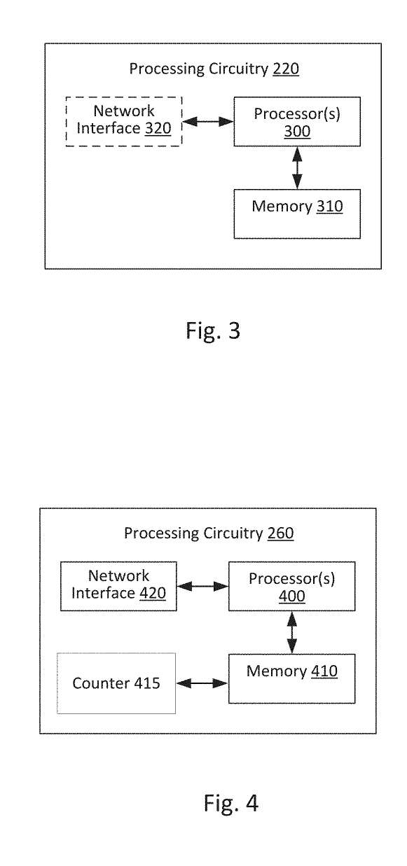

The processing circuitry 220 can comprise one or more processors 300, a memory 310 and optionally a network interface 320, as illustrated in FIG. 3. The processing circuitry 220 could comprise a web-connected Subscriber Identity Module (SIM) device, for example. The SIM device allows the server 200 to identify and recognize each pick-up device 110 and to be wirelessly connected to the server 200.

The one or more processors 300 executes instructions to provide some or all of the functionalities described above as being provided by the processing circuitry 220 or the pick-up device 110. The memory 310 stores the instructions for execution by the one or more processors 300, and the network interface 320 communicates signals from or to different components, such as the ticket scanner 210, the dispatch indicator 250, the registration indicator 230, the central server 200 through the antenna 240, etc.

The one or more processors 300 may include any suitable combination of hardware and software implemented in one or more devices to execute instructions and manipulate data to perform some or all of the described functions of the pick-up device 110, such as those described above. In some embodiments, the one or more processors 300 may include, for example, one or more computers, one or more central processing units (CPUs), one or more microprocessors, one or more applications, one or more application specific integrated circuits (ASICs), one or more field programmable gate arrays (FPGAs) and/or other logic.

The memory 310 is generally operable to store instructions, such as a computer program, software, an application including one or more of logic, rules, algorithms, code, tables, etc. and/or other instructions capable of being executed by one or more processors 300. Examples of memory 310 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

In some embodiments, the network interface 320 is communicatively coupled to the one or more processors 300 and may refer to any suitable device operable to receive input for the pick-up device 110, send output from the pick-up device 110, perform suitable processing of the input or output or both, communicate to other devices, or any combination of the preceding. The network interface 320 may include appropriate hardware (e.g., port, modem, network interface card, etc.) and software, including protocol conversion and data processing capabilities, to communicate through a network, for example.

Now, turning back to FIG. 2, each of the shuttle vehicles 140 has a dispatch device 130 installed therein and connected to the server 200. All the dispatch devices 130 are similar to each other, as such, for sake of simplicity, only one dispatch device 130 will be described.

The dispatch device 130 comprises a processing circuitry 260, a dispatch indicator 270, an antenna 280, optionally a ticket scanner 290 and optionally a feedback indicator 295.

The dispatch device 130 keeps track of the number or count of users waiting at each specific location, for a shuttle vehicle. To do so, the dispatch device 130 is connected to the server 200, through the antenna 280, via a cellular communication network, a WiFi communication network or any other wireless communication networks. Also, the dispatch device 130 is subscribed and registered to the server 200 for receiving events that, for example, report when a new user has notified the server 200 for a shuttle vehicle ride, through the pick-up device 110. These reported events are triggered when an identifier of a scanned service ticket is validated. They can be referred to as “new_user” events coming from the pick-up devices 110. Based on the received “new_user” events, the dispatch device 130 can keep track and count the number of users waiting for the shuttle vehicles at each specific location. More specifically, the processing circuitry 260 receives reports for the “new_user” events. Using counters, the processing circuitry 260 counts the number of users waiting for a vehicle ride or determines a count of users waiting for a ride. The processing circuitry 260 can use a counter to keep a count of users waiting at each pick-up location 120. Alternatively, the processing circuitry 260 can use a global counter to keep a count of users waiting at all the pick-up locations 120. However, when using the global counter, the dispatch devices 130 do not have the distribution of the users waiting for a vehicle per pick-up location 120.

The different counters can just keep the number of users waiting, or they can keep the number of users waiting, a list of identifiers of the service tickets of the waiting users and the corresponding timestamps.

After the processing circuitry 260 determines the count of users that requested a vehicle ride at each pick-up location 120, the processing circuitry 260 determines when and how many vehicles to dispatch, based on the determined count. Each dispatch device 130 can determine its own dispatching decision based on the determined count for each pick-up location 120 and further based on factors such as whether or not a vehicle is already on its way and the capacity of that vehicle. In the event that two vehicles are instructed to be dispatched at the same time by two dispatch devices 130, this event could be avoided by having a priority negotiation based on a static priority order established when the vehicles first registered with the system 100, for example.

As examples, the processing circuitry 260 could determine the number of vehicles to dispatch based on the determined count as follows. It should be noted that the determined count is the sum of all the counters, i.e. all the users waiting for a shuttle vehicle, at the different pick-up locations 120.

The processing circuitry 260 determines if the determined count of reported users waiting at each specific pick-up location 120 exceeds a number of times (N) a threshold value, N being an integer number, such as 1, 2, 3, etc. The threshold value is associated with the capacity of a shuttle vehicle. The threshold value could be the full capacity of the vehicle or a percentage of it. For example, the threshold value could be 90% of the capacity, in order to account for a buffer, which would allow to pick up people who arrive at the specific pick-up location 120 as the vehicle is on its way to the specific pick-up location 120.

Once the number N is determined, the processing circuitry 260 determines the number of vehicles needed, which corresponds to N. Then, the processing circuitry 260 can signal the dispatch indicator 270, which informs the N vehicles that they are to deploy. The dispatch indicator 270 could have a simple Light Emitting Diode (LED) or it could have a display that can indicate instructions such as which locations to go to. As each dispatch device 130 is registered and subscribed to the server 200, when the N vehicles are deployed, each dispatch device 130 knows which vehicles are deployed, how many are deployed and where they are going to.

For example, let's assume that the threshold value is K. If the determined count is 2K, i.e. 2K users are waiting at the pickup locations 120, then, a first dispatch device 130 determines that 2 shuttle buses are needed and should be deployed. But the dispatch device 130 of the second bus can further determine that the first shuttle bus has enough capacity to take all the users waiting at the first and second pick-up locations 120. Then, the dispatch device 130 will instruct the second shuttle bus to go directly to the third pick-up location 120, instead of following the default route (going to the first two pick-up locations). As such, the people waiting at the pick-up locations 120 closer to the destination 150 will be served as well.

In case the global counter is used, the processing circuitry 260 determines if the determined global count of reported users waiting at all the pick-up locations 120 exceeds a number of times (N) a threshold value. Once the number of N vehicles is determined, the N vehicles are deployed. In this case, there is not enough information regarding the distribution of the waiting users over the different pick-up locations 120. As such, the system 100 does not know if the first few pick-up locations are to be skipped or not. But, at least the vehicles will be deployed as soon as the global count exceeds the threshold value; this would ensure that the vehicles are not always full before the last pick-up location 120 on the route to the destination 150.

As another example, the processing circuitry 260 could determine the number of vehicles to dispatch based on the determined count and further based on the determination that a plurality of users have waited a time duration which exceeds a time threshold, at the different pick-up locations 120. The time threshold can be configured to be 5 minutes, 10 minutes, etc. For example, the time duration can be computed based on the received timestamps. Furthermore, the time duration could be an average time of all the users waiting for the shuttle vehicle or it could be the time that a user has waited the longest among the plurality of users waiting for a shuttle vehicle.

Alternatively, the processing circuitry 260 could wait for the determined count of reported waiting users to reach or exceed the threshold value by a number of times (N) before dispatching the vehicles.

Once the N vehicles are deployed, they can send a signal, using the feedback indicator 295, to the processing circuitry 260 of their dispatch device 130, for example. The signal can be a sound indication, a visual indication, a text message, etc.

Once the number of N vehicles is determined, the N vehicles could be selected and dispatched using different mechanisms, as will be described hereinbelow.

For example, the N vehicles can be selected and dispatched according to a prescribed order. The prescribed hierarchy/order determines which vehicle should go first once the number N of vehicles is determined. Alternatively, instead of a hierarchy, there could be a negotiation between the vehicles to know which vehicle will be deployed first, based on factors, such as which one is closer (in the case of a distributed fleet of vehicles) to the destination 150, for example. Furthermore, the dispatched vehicle can post an event to the server 200 to indicate that it has been dispatched. This posted event is received by all the vehicles. Furthermore, the posted event can also include which specific pick-up location 120 the dispatched vehicle is going to. The specific pick-up location 120 to go to can be determined based on how well the other pick-up locations have been served. For example, if the first few pick-up locations are being adequately serviced already, then the dispatched vehicle will go to the next one on the way to the destination 150.

Each dispatch device 130 can optionally have a ticket reader 290, which can be used to scan users' service tickets, for users that arrive just as the vehicle gets to the pick-up location 120, for example. In this case, the dispatch device 130 has a stored list of valid service ticket identifiers corresponding to registered users for the shuttle vehicles. The dispatch device 130 can post the event as a “Retrieved_Event” when a user scan his/her service ticket as they board the vehicle. The “Retrieved_Event” can also include the service ticket identifier. The “Retrieved_Event” is received by all the dispatch devices 130. As such, they can know how many people have been served at each pick-up location 120.

If a user holding a valid service ticket enters the vehicle but is not on the list of registered users waiting to be picked up, e.g. the user arriving just as the vehicle gets to the pick-up location 120, the dispatch device 130 can post both the “new_user” event and the “Retrieved_Event” to keep the count correct and updated.

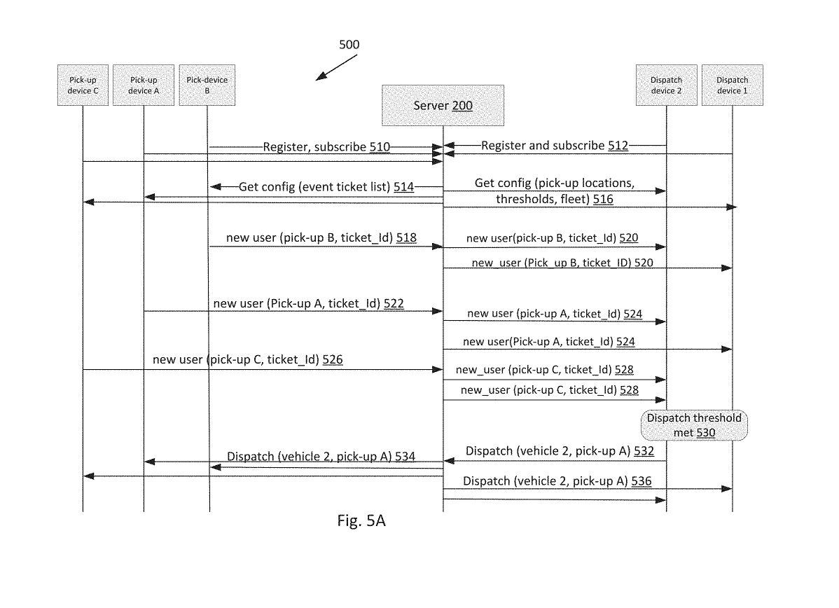

Now turning to FIG. 4, the processing circuitry 260 will be described in more detail.

The processing circuitry 260 can comprise one or more processors 400, a memory 410, a counter 415 and optionally a network interface 420, as illustrated in FIG. 4. The processing circuitry 260 could be a web-connected Subscriber Identity Module (SIM) device, for example. The SIM device allows the server 200 to identify and recognize each dispatch device 130 and to connect them.

The one or more processors 400 executes instructions to provide some or all of the functionalities described above as being provided by the processing circuitry 260 or the dispatch device 130. The memory 410 stores the instructions for execution by the one or more processors 400, and the network interface 420 communicates signals from or to network components, such as the ticket scanner 290, dispatch indicator 295, threshold indicator 270, the central server 200 through the antenna 280, etc.

The one or more processors 400 may include any suitable combination of hardware and software implemented in one or more devices to execute instructions and manipulate data to perform some or all of the described functions of the dispatch device 130, such as those described above. In some embodiments, the one or more processors 400 may include, for example, one or more computers, one or more central processing units (CPUs), one or more microprocessors, one or more applications, one or more application specific integrated circuits (ASICs), one or more field programmable gate arrays (FPGAs) and/or other logic.

The memory 410 is generally operable to store instructions, such as a computer program, software, an application including one or more of logic, rules, algorithms, code, tables, etc. and/or other instructions capable of being executed by one or more processors 400. Examples of memory 410 include computer memory (for example, Random Access Memory (RAM) or Read Only Memory (ROM)), mass storage media (for example, a hard disk), removable storage media (for example, a Compact Disk (CD) or a Digital Video Disk (DVD)), and/or or any other volatile or non-volatile, non-transitory computer-readable and/or computer-executable memory devices that store information.

The counter 415 is used for containing the number/count of users waiting at each pick-up location 120 for a shuttle bus. The counter 415 can also comprise the identifiers of the service tickets of the waiting users as well. The counter 415 could be part of the memory 410, for example.

In some embodiments, the network interface 420 is communicatively coupled to the one or more processors 400 and may refer to any suitable device operable to receive input for the dispatch device 130, send output from the dispatch device 130, perform suitable processing of the input or output or both, communicate to other devices, or any combination of the preceding. The network interface 420 may include appropriate hardware (e.g., port, modem, network interface card, etc.) and software, including protocol conversion and data processing capabilities, to communicate through a network, for example.

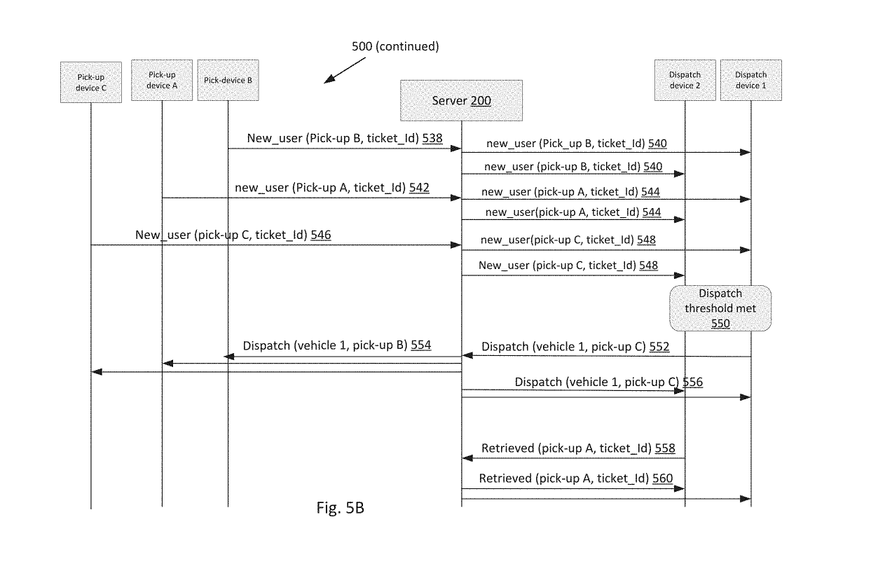

FIG. 5 illustrates a signaling diagram 500 between the different devices of the system 100. As a non-restrictive illustrative example, only 3 pick-up devices 110 are shown, pick-up devices A, B and C and only two dispatch devices 130 are shown, dispatch devices 1 and 2.

Method 500 starts, in step 510, with pick-up devices A, B and C registering and subscribing to the server 200.

In step 512, dispatch devices 1 and 2 also register and subscribe to the server 200.

The operations of registering and subscribing are well-known in the art and as such will not be described further.

After the pick-up devices A, B and C are registered, they can receive in step 514 some configuration information from the server 200. For example, they can get/download the list of service ticket identifiers, and other information. It should be noted that the pick-up devices A, B and C could get the list of service ticket identifiers and other information in other ways. For example, they can use a separate configuration server, they could do a manual download, or use a physical medium. The information could be even hardcoded in the pick-up devices A, B and C.

After the dispatch devices 1 and 2 are registered, they can also get configuration information from the server 200, in step 516. For example, they can get a list of the pick-up locations 120, the threshold value, information about the fleet of vehicles, the prescribed order for dispatching the vehicles, etc. The configuration information can be accessed using other ways, such as using a separate configuration server, a manual download, physical medium or even hardcodes, etc.

In step 518, when a user scans his/her service ticket at the pick-up location B, the pick-up device B sends a unique user message, e.g. “new_user” event, to the server 200. The message comprises the pick-up location (e.g. B) and the scanned service ticket identifier. Once the server 200 receives that message, it sends it to all the dispatch devices (1 and 2) to inform them about the user that is waiting for a shuttle vehicle at the pick-up location B, in step 520.

In step 522, a user scans his/her service ticket at the pick-up location A, then the pick-up device A sends a unique user message, e.g. “new_user” event, to the server 200. The message comprises the pick-up location (e.g. A) and the scanned service ticket identifier. Once the server 200 receives that message, it sends it to all the dispatch devices (1 and 2) to inform them about the user that is waiting for a shuttle vehicle at the pick-up location A, in step 524.

In step 526, a user scans his/her service ticket at the pick-up location C, then the pick-up device C sends a unique user message, e.g. “new_user” event, to the server 200. The message comprises the pick-up location (e.g. C) and the scanned service ticket identifier. Once the server 200 receives that message, it sends it to all the dispatch devices (1 and 2) to inform them about the user that is waiting for a shuttle vehicle at the pick-up location C, in step 528.

Steps 518 to 528 are repeated each time a new user scans his/her service ticket at pick-up location A, B or C.

As the dispatch devices 2 and 1 receive the “new_user” events, they can determine a count of the received messages per pick-up location 120. Then, the determined count is compared with the threshold value, which could be the capacity of a shuttle bus. For example, let's assume that they determine that the count exceeds the threshold value of a shuttle bus, in step 530.

In step 532, according to a dispatch mechanism, e.g. based on a prescribed order, vehicle 2 is to be deployed, for example. As such, the dispatch device 2 sends a message, called “dispatch” event to the server 200. The message comprises the identity of the vehicle (vehicle 2) that has been dispatched and the pick-up location (e.g. A) to which the vehicle has been dispatched. For example, pick-up location A could be the first pick-up location in the default route to the destination 150.

In step 534, the server 200 transmits this information (vehicle 2 has been dispatched to pick-up location A) to all the pick-up devices (A, B and C). Once the pick-up devices A, B and C receive this information, they can display it so that users waiting for the vehicle can see that there is a shuttle on its way to pick-up location A. The display could be just a light or electronic display of graphical and/or verbose data such as Estimated Time of Arrival (ETA).

In step 536, the server 200 transmits this information to all the dispatch devices (1 and 2) as well, so that the dispatch devices know which vehicles have been deployed and to which pick-up location.

As the vehicle 2 is heading to pick-up location A, the pick-up device B continues to receive service tickets. In step 538, it sends a unique user message, e.g. “new_user” event, to the server 200, each time it scans a service ticket.

The server 200 transmits this message to the dispatch devices 2 and 1, in step 540.

In step 542, the pick-up device A sends a “unique user” message, e.g. “new_user” event, to the server 200, as it scans more service tickets.

The server 200 transmits this message to the dispatch devices 2 and 1, in step 544.

In step 546, the pick-up device C sends a “unique user” message, e.g. “new_user” event, to the server 200, as it scans more service tickets.

The server 200 transmits this message to the dispatch devices 2 and 1, in step 548.

Steps 538 to 548 are repeated each time a new user scans his/her service ticket at pick-up location A, B or C.

The dispatch devices 2 and 1 determine a count of the received messages for all the pick-up locations 120. Then, the determined count is compared with the threshold value. Let's assume that the determined count exceeds the threshold value of a shuttle bus, in step 550.

According to the dispatch mechanism based on the prescribed priority, vehicle 1 is to be deployed after vehicle 2. Furthermore, the dispatch devices 1 and 2 can determine that vehicle 2 had enough capacity to pick up the users waiting at pick-up locations A and B, based on the counters of pick-up locations A and B. As such, vehicle 1 is instructed to skip pick-up locations A and B and to go directly to pick-up location C. Then, in step 552, the dispatch device 1 sends a message, called “dispatch event” to the server 200. The message comprises the identity of the vehicle (e.g. 1) that has been dispatched and the pick-up location (e.g. C) to which the vehicle has been dispatched.

In step 554, the server 200 transmits this information (vehicle 1 has been dispatched to pick-up location C) to the pick-up devices A, B and C.

In step 556, the server 200 transmits this information to all the dispatch devices (1 and 2) as well.

In the meantime, the vehicle 2 arrives at the pick-up location A. As it gets there, the users waiting for the shuttle vehicle start to board on. These users can use the ticket scanner 290 of the dispatch device 2 installed in the vehicle 2 to scan their service ticket. Once their service ticket is scanned, the dispatch device 2 sends a message, called the “retrieved_event” to the server 200, in step 558. The message comprises the pick-up location (e.g. A) and the service ticket identifier, for example. The “retrieved_event” is used to indicate that the waiting users registered in the system have been served.

In step 560, the server 200 transmits the “retrieved_event” to all the dispatch devices 1 and 2.

If there is capacity left for users that just arrive when the vehicle 2 is still at the pick-up location A, these users can scan their service tickets using the ticket scanner. Once their service ticket is scanned, the dispatch device 2 sends two messages to the server 200, one called the “new_user” event and one called the “retrieved_event”.

As can be seen in the above signaling diagram, the system 100 uses real-time data to count users waiting at each pick-up location and to determine one or more next shuttle buses to dispatch in order to optimize the passenger pick-up.

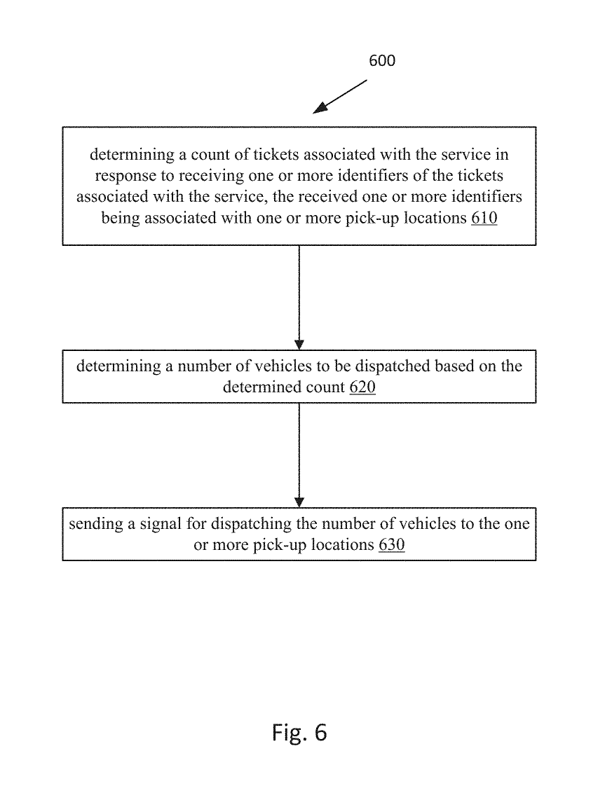

FIG. 6 illustrates a flowchart of a method 600 for dispatching vehicles to a destination associated with a service, according to an embodiment. The method can be performed by any of the dispatch devices 130, for example. In order to access the service, users have purchased tickets associated with the service, called service tickets. A service of transportation is offered to those users, at different pick-up locations.

Method 600 starts with determining a count of tickets associated with the service in response to receiving one or more identifiers of the tickets associated with the service, the received one or more identifiers being associated with one or more pick-up locations (step 610).

The method 600 continues with determining a number of vehicles to be dispatched based on the determined count (step 620).

The method 600 continues with sending a signal for dispatching the number of vehicles to the one or more pick-up locations (step 630).

In some embodiments, the identifiers of the service tickets could include one of a Radio Frequency Identification (RFID), a barcode and a scannable identifier.

In some embodiments, the received one or more identifiers of the tickets comprise one or more valid identifiers of the tickets, which have been compared against a list of valid ticket identifiers associated with the service.

In some embodiments, determining the number of vehicles to be dispatched comprises determining a number of times that the determined count exceeds a threshold value, the threshold value corresponding to a capacity of the vehicle. Additionally, a dispatch device could determine that a time duration over which users have been waiting for a vehicle at the one or more pick-up locations has exceeded a time threshold.

In some embodiments, sending the signal for dispatching the number of vehicles comprises sending a signal to dispatch the number of vehicles according to a prescribed order to know which vehicle should be deployed.

In some embodiments, sending the signal for dispatching the number of vehicles comprises sending a signal to dispatch the number of vehicles according to a proximity factor with regards to the one or more pick-up locations.

In some embodiments, determining a number of vehicles to be dispatched further comprises determining that a first vehicle has enough capacity to serve users waiting at the first few pick-up locations, based on the counters of the first few pick-up locations and determining that a second vehicle can go directly to serve the next pick-up location.

It should be noted that method 600 and the different embodiments could be performed by the processing circuitry 260 of any of the dispatch devices 130 and more particularly by the one or more processors 400, in combination with the network interface 420 and the memory 410. The memory 410 may comprise all the instructions, that when executed, cause the one or more processors 400 to perform method 600 and the different embodiments.

It should be noted that other exemplary designs of the pick-up device 110 and dispatch device 130 are possible.

According to an embodiment, the pick-up device 110 of FIG. 2 can be reduced to a simple device, such as a ticket scanner.

For example, the ticket scanner 210 receives and extracts the identifiers of the tickets associated with a service. Then, the ticket scanner 210 sends the identifiers (or a number of identifiers) to the server 200, which will relay the information to the dispatch device 130. Alternatively, the pick-up device 110 can directly send the identifiers (or a number of identifiers) directly to the dispatch devices 130. In such cases, the ticket scanner has a processing circuitry to execute the above described operations.

Once the dispatch devices 130 receive the service ticket identifiers from the server 200, they can validate them by comparing them with a list of valid service ticket identifiers. Then, they determine a count of service ticket identifiers among the validated identifiers. They further determine a number of vehicles to be dispatched based on the determined count and then send a signal, to the dispatch indicator 270 for example, for dispatching the determined number of vehicles to the one or more pick-up locations.

In another embodiment, the dispatch device 130 could be a simple device for receiving a signal when its associated vehicle is selected to be dispatched.

More specifically, the processing circuitry 220 of the pick-up device 110 receives and extracts the identifiers of the tickets associated with a service. It validates the extracted identifiers by comparing them against a list of valid service ticket identifiers. Then, it determines a count of service tickets among the validated identifiers. It further determines a number of vehicles to be dispatched based on the determined count and then sends a signal to the server 200 (or directly to the dispatch device 130) for dispatching the number of vehicles to the one or more pick-up locations. In this case, the pick-up device 110 performs some of the operations that were performed by the dispatch device 130 according to the embodiment described with regards to FIG. 2. As such, in this embodiment, there is no need for the processing circuitry 220 to send the “new_user” event (or the extracted identifiers) to the dispatch device 130.

In another embodiment, the pick-up device 110 receives and extracts the identifiers of the tickets associated with a service. It sends them to the server 200. Once the server 200 receives the identifiers, it can validate the identifiers by comparing them against a list of valid service ticket identifiers. Then, it can determine a count of service tickets among the validated identifiers. It can further determine a number of vehicles to be dispatched based on the determined count and then send a signal to the dispatch devices 130 of the vehicles that are to be dispatched to one or more pick-up locations 120.

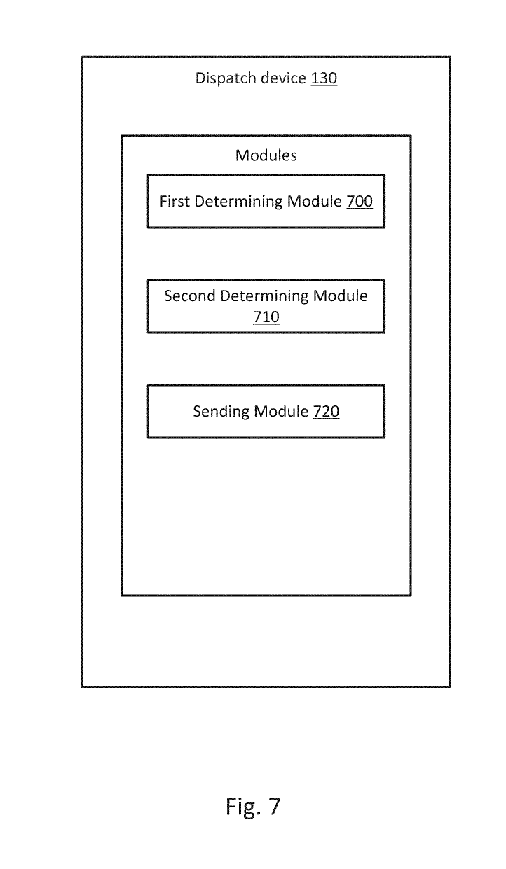

Now turning to FIG. 7, the dispatch device 130 according to another embodiment will be described. The dispatch device 130 may comprise a first determining module 700, a second determining module 710 and a sending module 720 that may perform steps or functions described herein in relation with FIG. 6.

For example, the first determining module 700 is configured to determine a count of tickets associated with the service in response to receiving one or more identifiers of the tickets associated with the service, the received one or more identifiers being associated with one or more pick-up locations.

The second determining module 710 is configured to determine a number of vehicles to be dispatched based on the determined count.

The sending module 720 is configured to send a signal for dispatching the number of vehicles to the one or more pick-up locations.

Each functional module may comprise software, computer programs, sub-routines, libraries, source code, or any other form of executable instructions that are executed by, for example, a processor. In some embodiments, each functional module may be implemented in hardware and/or in software. For example, one or more or all functional modules may be implemented by processors 400 possibly in cooperation with memory 410. Processors 400 and memory 410 may thus be arranged to allow processors 400 to fetch instructions from memory 410 and execute the fetched instructions to allow the respective functional module to perform any steps or functions disclosed herein.

It should be noted that the pick-up devices 110 and/or the dispatch devices 130 could be running in a cloud environment and could be virtualized.

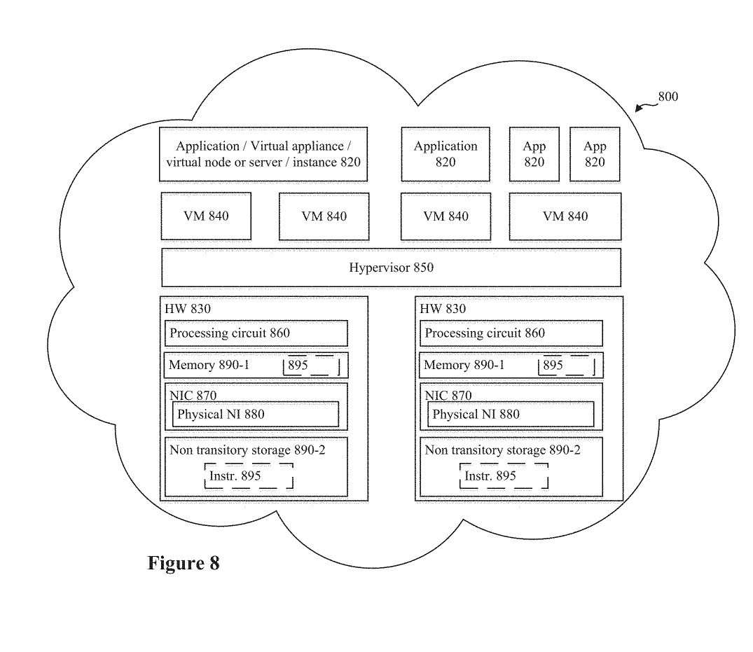

Turning to FIG. 8, there is provided an instance or a virtual appliance 820 implementing the methods or parts of the methods of some embodiments. The instance runs in a cloud computing environment 800 which provides processing circuit 860 and memory 890. The memory contains instructions 895 executable by the processing circuit 860 whereby the instance 820 is operative to execute the methods or part of the methods previously described in relation to some embodiments.

The cloud computing environment 800 comprises a general-purpose network device including hardware 830 comprising a set of one or more processor(s) or processing circuits 860, which may be commercial off-the-shelf (COTS) processors, dedicated Application Specific Integrated Circuits (ASICs), or any other type of processing circuit including digital or analog hardware components or special purpose processors, and network interface controller(s) 870 (NICs), also known as network interface cards, which include physical Network Interface 880. The general-purpose network device also includes non-transitory machine readable storage media 890-2 having stored therein software and/or instructions 895 executable by the processor 860. During operation, the processor(s) 860 execute the software/instructions 895 to instantiate a hypervisor 850, sometimes referred to as a virtual machine monitor (VMM), and one or more virtual machines 840 that are run by the hypervisor 850.

A virtual machine 840 is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes. Each of the virtual machines 840, and that part of the hardware 830 that executes that virtual machine, be it hardware dedicated to that virtual machine and/or time slices of hardware temporally shared by that virtual machine with others of the virtual machine(s) 840, forms a separate virtual network element(s) (VNE).

The hypervisor 850 may present a virtual operating platform that appears like networking hardware to virtual machine 840, and the virtual machine 840 may be used to implement functionality such as control communication and configuration module(s) and forwarding table(s), this virtualization of the hardware is sometimes referred to as network function virtualization (NFV). Thus, NFV may be used to consolidate many network equipment types onto industry standard high volume server hardware, physical switches, and physical storage, which can be located in Data centers, and customer premise equipment (CPE). Different embodiments of the instance or virtual appliance 820 may be implemented on one or more of the virtual machine(s) 840, and the implementations may be made differently.

The present teachings disclose a first service with which a transportation service (i.e. second service) is associated. They also disclose using the tickets associated with the first service to control the second service (transportation service).

One example of the first service can be an event, for which shuttle buses (second service) are made available to transport people to the event site, as described above.

A second example of the first service can be a normal bus service, for which a supplemental bus service (i.e. second service) can be made available. The normal bus service serves a plurality of pick-up locations at prescribed times. When there is a congestion in one part of the bus route, the present teachings can be used to dispatch the supplemental buses via uncongested route just to service the pick-up locations not near the congestions. Those pick-up locations are provided with the pick-up devices 110.

A third example of the first service can be an airplane flight, a cruise, a train ride, etc., for which a shuttle service (i.e. second service) is provided. The shuttle buses can pick-up people from different hotels and take them to the airport or train station or cruise terminal. The airplane or cruise or train ticket are scanned and counted. The number of shuttle buses is dispatched based on the count at the pick-up locations (e.g. hotels).

A fourth example could be the reverse of the third example. For example, in the 4th example, the first service is the hotel and a shuttle service (i.e. second service) is offered to pick up people from different terminals (airport, train, harbour, etc.) to the hotel. Using their “hotel ticket” or receipt, users are counted and a number of shuttle buses is dispatched based on the count at the different terminals.

A fifth example is similar to the fourth example, but instead of the hotel, it is a park and ride service. Shuttle buses (i.e. second service) are offered to users to pick them up from different terminals.

A sixth example of the first service can be a movie. Shuttle buses (i.e. second service) are made available to bring people to the movie theatre. In this case, the pick-up device 110 could be an application on the smart phone of the users, that can scan the movie ticket. The location of the user can be detected by the GPS of the smart phones. The movie ticket and the location information can be sent to the dispatch devices 130 so that shuttle buses can be dispatched to the users in the area.

Other examples are possible.

Furthermore, the vehicles could be driveless, e.g. self-driving vehicles. The dispatch signal can instruct the vehicles where to go and when to go.

The above-described embodiments allow to distribute the waiting times across a plurality of pick-up locations. By so doing, the waiting time for a shuttle bus is reduced and the ridership on the shuttle bus is improved. Furthermore, the operation of the shuttle buses could be monetized by the shuttle service as an upgrade package sold to event organizers, hotel administrators, movie theater administrator, park and ride administrators, etc.

Modifications and other embodiments will come to mind to one skilled in the art having the benefit of the teachings presented in the foregoing description and the associated drawings. Therefore, it is to be understood that modifications and other embodiments, such as specific forms other than those of the embodiments described above, are intended to be included within the scope of this disclosure. The described embodiments are merely illustrative and should not be considered restrictive in any way. The scope sought is given by the appended claims, rather than the preceding description, and all variations and equivalents that fall within the range of the claims are intended to be embraced therein. Although specific terms may be employed herein, they are used in a generic and descriptive sense only and not for purposes of limitation.

What is claimed is:

1. A method for dispatching vehicles to a destination that is associated with a service, the method comprising:
determining a count of tickets associated with the service in response to receiving one or more identifiers of the tickets associated with the service, the received one or more identifiers being associated with one or more pick-up locations;
determining a number of vehicles to be dispatched based on the determined count; and
sending a signal for dispatching the number of vehicles to the one or more pick-up locations.

2. The method of claim 1, wherein the identifiers include one of a Radio Frequency Identification (RFID), a barcode and a scannable identifier.

3. The method of claim 1, wherein receiving the one or more identifiers of the tickets comprises receiving one or more valid identifiers of the tickets, which have been compared against a list of valid ticket identifiers associated with the service.

4. The method of claim 1, wherein determining a number of vehicles to be dispatched comprises determining a number of times that the determined count exceeds a threshold value, the threshold value corresponding to a capacity of a vehicle.

5. The method of claim 4, wherein determining a number of vehicles to be dispatched further comprises determining that a time duration over which users have been waiting for a vehicle at the one or more pick-up locations has exceeded a time threshold.

6. The method of claim 1, wherein sending a signal for dispatching the number of vehicles comprises sending a signal to dispatch the number of vehicles according to a prescribed order to know which vehicle should be deployed.

7. The method of claim 1, wherein sending a signal for dispatching the number of vehicles comprises sending a signal to dispatch the number of vehicles according to a proximity factor with regards to the one or more pick-up locations.

8. The method of claim 1, wherein determining a number of vehicles to be dispatched further comprises determining that a first vehicle has enough capacity to serve users waiting at first few pick-up locations, based on counters associated with the first few pick-up locations and determining that a second vehicle can go directly to serve a next pick-up location.

9. A device for dispatching vehicles to a destination associated with a service, the device comprising a processing circuitry adapted to cause the device to:
determine a count of tickets associated with the service in response to receiving one or more identifiers of the tickets associated with the service, the received one or more identifiers being associated with one or more pick-up locations;
determine a number of vehicles to be dispatched based on the determined count; and
send a signal for dispatching the number of vehicles to the one or more pick-up locations.

10. The device of claim 9, wherein the processing circuitry comprises a processor, a memory and a network interface both coupled with the processor, the memory containing instructions that, when executed, cause the processor to perform the operations of determining the count of tickets associated with the service, determining the number of vehicles to be dispatched based on the determined count; and sending the signal.

11. The device of claim 9, wherein the identifiers include one of a Radio Frequency Identification (RFID), a barcode and a scannable identifier.

12. The device of claim 10, wherein the processor is further configured to determine a number of times that the determined count exceeds a threshold value, the threshold value corresponding to a capacity of the vehicle.

13. The device of claim 10, wherein the processor is further configured to determine that a time duration over which users have been waiting for a vehicle at the one or more pick-up locations has exceeded a time threshold.

14. The device of claim 10, wherein the processor is configured to send a signal for dispatching the number of vehicles according to a prescribed order to know which vehicle should be deployed.

15. The device of claim 10, wherein the processor is configured to dispatch the number of vehicles according to a proximity factor with regards to the one or more pick-up locations.

16. The device of claim 10, wherein the processor is configured to determine that a first vehicle has enough capacity to serve users waiting at first few pick-up locations, based on counters of the first few pick-up locations and to determine that a second vehicle can go directly to serve a next pick-up location.

17. A system for dispatching vehicles to a destination associated with a service, the system comprising at least one pick-up device and at least one dispatch device, wherein the at least one pick-up device and the at least one dispatch device are connected to a server, the at least one pick-up device and at least one dispatch device being configured to cause the system to:
receive one or more identifiers of tickets associated with the services, at one or more pick-up locations;
send the received one or more identifiers to the server, which transmits the one or more identifiers to the at least one dispatch device;
determine a count of tickets associated with the service in response to receiving the one or more identifiers;
determine a number of vehicles to be dispatched based on the determined count; and
send a signal to the number of vehicles to be dispatched to the one or more pick-up locations.

18. The system of claim 17, wherein the at least one pick-up device is further adapted to validate the received one or more identifiers by comparing them against a list of valid identifiers of tickets associated with the service.

19. The system of claim 17, wherein the at least one dispatch device is further configured to determine a number of times that the determined count exceeds a threshold value, the threshold value corresponding to a capacity of the vehicle.

20. The system of claim 17, wherein the at least one dispatch device is configured to determine that a first vehicle has enough capacity to serve users waiting at first few pick-up locations, based on counters of the first few pick-up locations and to determine that a second vehicle can go directly to serve a next pick-up location.
